(19) United States
(12) Patent Application Publication
(10) Pub. No.: US 2005/0023909 A1
(43) Pub. Date: Feb. 3, 2005

(54) Automotive generator

(76) Inventors: Joseph Charles Cromas, Northville, MI (US); Susumu Tajima, Ibaraki-ken (JP)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/933,756

(22) Filed: Sep. 3, 2004

Related U.S. Application Data
(63) Continuation-in-part of application No. 10/171,045, filed on Jun. 13, 2002.

(51) Int. Cl. H02K 9/00; H02K 5/18; H02K 5/20

(52) U.S. Cl. 310/58

(57) ABSTRACT

An electric generator for use with an automotive vehicle having a liquid coolant system includes a main housing defining a closed interior chamber. A stator is mounted within the housing around the interior chamber while a liquid cooled passageway is formed in the housing around the stator. At least two fluid ports are open to the liquid coolant passageway adjacent opposite ends of the liquid coolant passageway and these fluid ports are adapted for fluid connection with the coolant system of the vehicle. A rotor having two axial ends is rotatably mounted to the housing within the interior chamber. A gas flow passageway is open at one end to the interior chamber adjacent one end of the rotor and is open at its other end to the interior chamber adjacent the other end of the rotor. A midportion of this gas flow passageway extends through a gas flow housing positioned exteriorly of the main housing and thermally coupled to the liquid coolant passageway in the main housing. A fan attached to the rotor circulates gas through the interior chamber and gas flow passageway during operation of the generator thereby cooling the generator.

### RELATED APPLICATION

This application is a continuation-in-part of U.S. patent application Ser. No. 10/171,045 filed Jun. 13, 2002.

### BACKGROUND OF THE INVENTION

I. Field of the Invention

The present invention relates generally to generators and, more particularly, to a water cooled generator for automotive vehicles.

II. Description of the Prior Art

Electric generators and alternators (herein collectively referred to as “generators”) of the type used in automotive vehicles typically comprise a housing having a stator which defines a cylindrical interior chamber. A rotor is then rotatably mounted to the housing within the interior chamber so that, upon rotation, the rotor generates electricity necessary to power the electrical system of the vehicle and/or charge the vehicle's battery.

During the operation of the electric generator, the generator, and especially the rotor, becomes heated as a result of the current flow through the generator windings. Excessive heat, furthermore, can damage the generator and otherwise degrade the operation of the generator by a number of factors. For example, excessive heat can not only damage the bearings utilized to rotatably mount the rotor to the housing and the generator electronics, but excessive heat can also effectively demagnetize, either partially or wholly, the magnetic components of the generator.

In order to properly cool the generator during operation, it has been the previous practice to provide air flow passageways through the generator housing which are open not only to the stator but also to the rotor. Consequently, during the operation of the automotive vehicle, the air flow through these cooling air passageways cooled the generator components.

These previously known electric generators, however, have not proven entirely satisfactory in all applications. For example, in many automotive applications the under-hood space for the automotive vehicle is limited which results in limited and inadequate air flow through the electric generator.

A still further disadvantage of these previously known electric generators with air flow passageways formed through the generator housing is that environmental elements, such as moisture, grease, oil, road debris and the like which may be entrained in the air flow necessarily passes through the cooling passageway formed in the generator housing. Such debris or other contaminants can disadvantageously damage the generator components causing malfunction or a shortened lifespan of the electric generator. This problem, furthermore, is particularly enhanced where the generator is mounted at a low position in the engine compartment and thus closer to the road surface.

In order to overcome these previously known disadvantages of air cooled electric generators, there have been a number of previously known liquid cooled electric generators. In these previously known liquid cooled generators, a liquid jacket or passageway is formed in the generator housing around the stator. This liquid passageway is then connected to the coolant system for the automotive vehicle so that, during operation of the automotive vehicle, the coolant flows through the coolant passageway thus cooling the generator. In this type of previously known liquid cooled generator, the generator housing is otherwise closed to air flow through the generator housing thus protecting the generator components from damage from the environment, such as road debris, moisture and the like.

One disadvantage of these previously known liquid cooled generators, however, is that the liquid coolant jacket can only be formed around the exterior of the stator and thus only effectively cools the stator and its adjacent housing. Conversely, the rotor which is rotatably mounted with a closed air chamber within the stator receives little or no cooling from the liquid cooled passageways. Although some of these previously known liquid cooled generators have attached fans or the like to the rotor in order to produce air flow around the rotor during operation of the generator, after prolonged periods of time, these fans merely circulate hot air around the closed rotor chamber and do not adequately cool the generator rotor.

### SUMMARY OF THE PRESENT INVENTION

The present invention provides a liquid cooled generator which overcomes all of the above-mentioned disadvantages of the previously known devices.

In brief, the electric generator of the present invention is provided for use with an automotive vehicle or the like having a liquid coolant system. Furthermore, as used in this patent, the term “automotive” includes not only automobiles, trucks, SUVs and the like, but other types of vehicles, such as agricultural vehicles and industrial applications.

The electric generator includes a main housing which defines a closed interior chamber. A stator is mounted within the housing around this interior chamber while a rotor is rotatably mounted to the housing within the interior chamber.

A liquid coolant passageway is formed in the housing around the stator. At least two fluid ports are open to the liquid coolant passageway adjacent opposite ends of the liquid coolant passageway. These fluid ports are adapted for fluid connection to the liquid coolant system of the automotive vehicle so that, upon operation of the vehicle, coolant from the liquid coolant system of the automotive vehicle passes through the liquid coolant passageway and cools the stator and housing with the engine liquid coolant.

A gas flow housing having a gas flow passageway is then mounted on the exterior of the main housing so that one end of the gas flow passageway is fluidly coupled to one end of the interior chamber adjacent one end of the rotor. The other end of the gas flow passageway is also fluidly coupled to the interior chamber but is open adjacent the other end of the rotor. The gas flow housing is thermally connected to the liquid coolant passageway formed in the housing.

At least one fan or turbine is mounted to the rotor so that the fan rotates in unison with the rotor. This fan, upon rotation of the rotor, thus circulates air not only through the interior chamber in which the rotor is mounted, but also through the gas flow passageway in the gas flow housing before the recirculated gas is reintroduced into the housing interior chamber. The circulation of the gas through the gas flow passageway is thus cooled, preferably by the coolant from the vehicle liquid coolant system, thus maintaining the rotor at an acceptable operating temperature. This allows a near totally sealed generator design.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a perspective view illustrating a preferred embodiment of the present invention;

FIG. 2 is a longitudinal sectional view taken substantially along line 2-2 in FIG. 1; and

FIG. 3 is a flowchart illustrating the preferred method of the present invention.

### DETAILED DESCRIPTION OF A PREFERRED EMBODIMENT OF THE PRESENT INVENTION

With reference to the drawing, a preferred embodiment of the generator 10 of the present invention is there shown and comprises a main housing 12 having a closed generally cylindrical interior chamber 14. As used in this patent, the term “closed interior chamber” means that the housing 12 prevents the passage of external air through the housing chamber 14 for cooling purposes. However, the housing 12 may include one or more pressure relief ports 16 which merely equalize the pressure between the interior chamber 14 and exteriorly of the generator housing 12 but are inadequate in either size or function to allow cooling air flow to pass through the housing 12 and interior chamber 14 to cool the generator 10.

With reference now particularly to FIG. 2, the generator 10 includes a stator 18 which is mounted to the housing 12 around the interior chamber 14. A rotor 20 is then rotatably mounted to the housing 12 by bearing assemblies 22, illustrated only diagrammatically, such that the rotor 20 rotates within the closed interior chamber 14 coaxially within the stator 18.

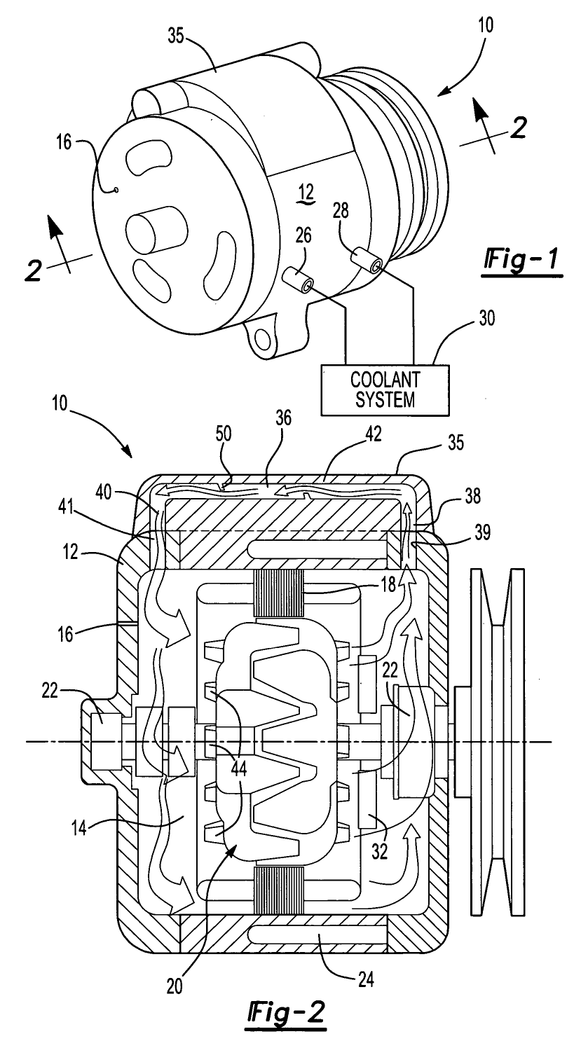

Referring again to both FIGS. 1 and 2, a liquid coolant passageway 24 is formed within the housing 12 at a position spaced radially outwardly from the stator 18. At least two fluid ports 26 and 28 are open to the liquid coolant passageway 24 adjacent opposite ends of the liquid coolant passageway 24. These fluid ports 26 and 28 are fluidly connected with a liquid coolant system 30 (illustrated diagrammatically) of an automotive vehicle. Thus, upon operation of the automotive vehicle, the liquid coolant system 30 circulates liquid coolant through the coolant passageway 24 thus cooling the stator 18, housing 12 as well as any electronics 32 (illustrated only diagrammatically) contained within the housing.

An elongated gas flow housing 35 is mounted to an exterior surface of the main housing 12 or, alternatively, formed as a part of the main housing 12, so that the gas flow housing 35 extends axially along the main housing 12. A gas flow passageway 36 is formed through the gas flow housing 35 and has one end 38 fluidly connected through a housing port 39 to the interior chamber 14 adjacent one end of the rotor 20. The other end 40 of the gas flow passageway 36 is fluidly connected through a housing port 41 to the interior chamber 14 adjacent the other end of the rotor 20. A midportion 42 of the gas flow passageway 36 extends axially along the outside of the main housing 12. Preferably, the midportion 42 of the passageway 36 extends across at least a portion of the stator 18 and is thermally coupled with the liquid coolant passageway 24. Furthermore, although only one gas flow passageway 36 is illustrated in the drawing, it will be understood that multiple gas flow passageways at different circumferential positions around the outside of the main housing 12 may alternatively be employed.

Preferably, at least one fan 44 is secured to the rotor 20 so that the fan 44 rotates in unison with the rotor 20. Thus, upon rotation of the rotor 20, the fan 44 circulates air through the gas flow passageway 36 and thus through the interior chamber 14. Since the midportion 42 of the gas flow passageway 36 is at a position thermally cooler than the interior chamber 14, and preferably thermally cooled by the liquid coolant passageway 24, the gas flow through the gas flow passageway 36 is cooled prior to its reintroduction into and recirculation through the interior chamber 14.

In order to enhance the heat transfer from the midportion 42 of the gas flow passageway 36, one or more heat transfer devices, such as baffles 50 (illustrated only diagrammatically) may be contained within the gas flow passageway 36 in order to create turbulence of the gas flow through the gas flow passageway 36. Additionally, although the interior chamber 14 is preferably filled with a gas such as air, other types of gas, such as argon, may alternatively be used.

Furthermore, since the gas flow housing 25 is positioned outside the main housing 12, the gas flow through the passageway is also cooled by ambient air flow around the gas flow passageway.

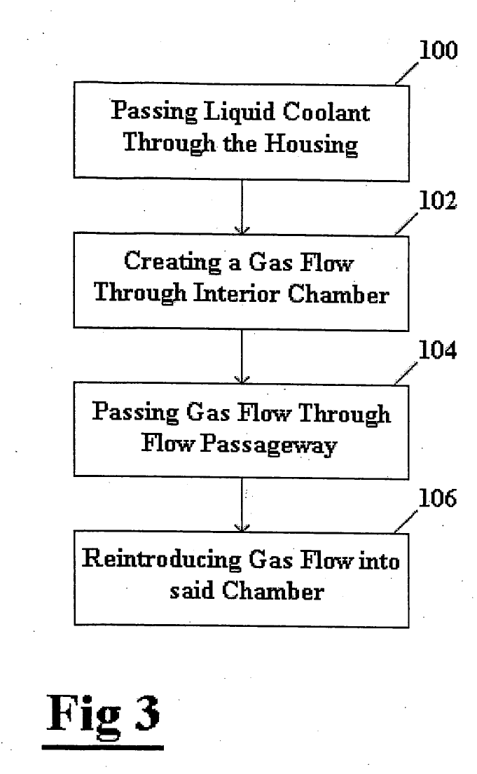

With reference now to FIGS. 2 and 3, a flowchart illustrating the preferred method of the present invention is shown in FIG. 3. At step 100 a liquid coolant is first passed through the housing thus cooling the housing. This coolant passage preferably surrounds the stator.

At step 102 a gas flow is created through the interior chamber 14. Preferably the fan creates this gas flow.

At step 104 the gas flow through the interior chamber 14 is passed from one end of the interior chamber 14 to the other end of the interior chamber 14 via the gas flow passageway 36 thus cooling the gas in the gas flow. Since the gas flow passageway is thermally coupled to the portion of the housing cooled by the liquid coolant, the liquid coolant further enhances the cooling of the gas in the gas flow passageway 36.

The gas flow through the gas flow passageway 36 is then reintroduced to the interior chamber 14 at step 106 at the opposite end of the interior chamber 14 for recirculation through the interior chamber 14 and gas flow passageway 36.

From the foregoing, it can be seen that the present invention provides a liquid cooled generator particularly suited for use in an automotive vehicle which cools not only the stator, but also the rotor. Furthermore, the generator of the present invention achieves cooling of the rotor even within a closed housing design so that environmental debris, contaminants and the like cannot enter the interior of the generator housing 12 and, therefore, cannot damage the components of the generator 10. Having described my invention, however, many modifications thereto will become apparent to those skilled in the art to which it pertains without deviation from the spirit of the invention as defined by the scope of the appended claims.

1. An electric generator comprising:
a main housing defining a closed interior chamber which prevents the passage of external air through said housing chamber,
a rotor having two axial ends, said rotor being rotatably mounted to said housing within said interior chamber,
a gas flow housing mounted exteriorly of said main housing,
a gas flow passageway in said gas flow housing, said gas flow passageway being open at one end to said interior chamber adjacent one end of said rotor and open at its other end to said interior chamber adjacent the other end of said rotor,
a fan mounted to one axial end of said rotor within said housing chamber,
whereby rotation of said fan creates a gas flow through said gas flow passageway and axially along said rotor.

2. The invention as defined in claim 1 and comprising a heat transfer device in said gas flow passageway, said heat transfer device creating turbulence in air flow through said gas flow passageway.

3. The invention as defined in claim 2 wherein said heat transfer device is positioned at least partially in said midportion of said gas flow passageway.

4. The invention as defined in claim 1 wherein said electric generator comprises an automotive electric generator.

5. The invention as defined in claim 1 wherein said electric generator comprises an alternator.

6. The invention as defined in claim 1 wherein said main housing comprises a liquid coolant chamber formed in a portion of said main housing.

7. The invention as defined in claim 6 and further comprising a stator mounted in said main housing, said liquid coolant chamber being formed in said main housing around at least a portion of said stator.

8. The invention as defined in claim 7 and comprising at least two fluid ports on said main housing and open to said liquid coolant chamber.

9. The invention as defined in claim 1 wherein said interior chamber is substantially filled with argon gas.

10. The invention as defined in claim 1 wherein said gas flow passageway is spaced radially outwardly from said stator.

11. A method for cooling an electric generator having a rotor rotatably mounted in a closed interior chamber of a main housing comprising the steps of:
creating a gas flow from one end and to a second end of the interior chamber,
passing gas flow from said second end of said interior chamber through a gas flow passageway in a gas flow housing having a portion extending axially along an outside of said main housing at a position radially spaced from the chamber, and
thereafter reintroducing the gas flow from said gas flow passageway into said first end of said interior chamber.

12. The invention as defined in claim 11 and comprising the step of passing a liquid coolant through a portion of said housing.

13. An electric generator for use with an automotive vehicle having a liquid coolant system comprising:
a main housing defining a closed interior chamber which prevents the passage of external air through said housing chamber,
a stator mounted in said housing around said interior chamber,
a liquid coolant passageway formed in said housing around said stator,
at least two fluid ports open to said liquid coolant passageway adjacent opposite ends of said liquid coolant passageway, said fluid ports adapted for fluid connection with the coolant system of the vehicle,
a rotor having two axial ends, said rotor being rotatably mounted to said main housing within said interior chamber,
a gas flow housing mounted to an exterior of said main housing and having a gas flow passageway open at one end to said interior chamber adjacent one end of said rotor and open at its other end to said interior chamber adjacent the other end of said rotor,
a fan mounted to one axial end of said rotor within said housing chamber,
whereby rotation of said fan creates a gas flow through said gas flow passageway and axially along said rotor.

14. The invention as defined in claim 13 and comprising a heat transfer device in said gas flow passageway, said heat transfer device creating turbulence in air flow through said gas flow passageway.

15. The invention as defined in claim 14 wherein said heat transfer device is positioned at least partially in said midportion of said gas flow passageway.

16. The invention as defined in claim 13 wherein said electric generator comprises an automotive electric generator.

17. The invention as defined in claim 13 wherein said electric generator comprises an alternator.

18. The invention as defined in claim 13 wherein said interior chamber is substantially filled with argon gas.

19. The invention as defined in claim 13 wherein said gas flow passageway is spaced radially outwardly from said stator.
